(19) United States
(12) Patent Application Publication
(10) Pub. No.: US 2003/0098975 A1
(43) Pub. Date: May 29, 2003

(54) Optical spectrum analyzer and optical spectrum measuring method

(75) Inventors: Tohru Mori, Yokohama-shi (JP); Tsutomu Kaneko, Yokohama-shi (JP); Toshikazu Yamamoto, Kawasaki-shi (JP)

Correspondence Address: COHEN, PONTANI, LIEBERMAN & PAVANE, 551 FIFTH AVENUE, SUITE 1210, NEW YORK, NY, 10176, US

(73) Assignee: Ando Electric Co., Ltd., Tokyo (JP)

(21) Appl. No.: 10/302,379

(22) Filed: Nov. 22, 2002

(30) Foreign Application Priority Data
Nov. 26, 2001 (JP) 2001-360000

(51) Int. Cl. G01J 3/28; G01J 3/18

(52) U.S. Cl. 356/328

(57) ABSTRACT

An optical spectrum analyzer comprises a refractive grating which extracts a specific wavelength of light which is incident to be measured and outputs as a component light, an optical detector which measures optical intensity of the component light, a container in which the refractive grating and the optical detector are provided, a gas filling port and a gas exhaust port, for performing a replacement of air with a gas, which are provided in the container, are provided. By doing this, the optical spectrum analyzer which can measure level of the light to be measured having a specific wavelength accurately without causing the absorption of the specific wavelength by an OH group.

### BACKGROUND OF THE INVENTION

1. Field of the Invention

The present invention relates to an optical spectrum analyzer on which a spectroscope having a refractive grating is mounted.

2. Description of Related Art

An optical spectrum analyzer is a measuring instrument which is used for a high-speed communication system which employs optical fiber technology. In this technology, greater precision has been required along with the development of the communication technology.

In particular, demand for an optical spectrum analyzer which corresponds to a new technology in the optical communication systems such as WDM (Wavelength Division Multiplexing) increases; thus, it is necessary to improve all of the specifications such as time-resolution, reliability, and dynamic range.

A conventional optical spectrum analyzer 100 has a structure shown in FIG. 4.

A light L to be measured which is incident from an incident fiber 5 is converted to a parallel light by a concave mirror 7 via an incident slit 6.

Subsequently, a refractive grating 8 reflects only a specific wavelength component of the light L to be measured which was converted to the parallel light so as to be emitted to a concave mirror 10.

By doing this, an optical detector 2 receives the specific wavelength component of the light to be measured which is collected by the concave mirror 10 via an emitting slit 11; thus, the level of the optical intensity is measured.

In addition, a control section 3 displays images indicating a relationship of a selected wavelength for a specific wavelength component and an optical intensity which is obtained based on an electric detection signal which corresponds to the output level of the optical detector 2 on a displaying apparatus 4.

As explained above, the optical spectrum analyzer 100 disperses the incident light L to be measured into spectra by an optical element such as a refractive grating 8. By moving the angle of the optical element, the wavelength to be measured in the light to be measured is selected.

Also, as shown in the conventional case shown in FIG. 4, a measuring system in the optical spectrum analyzer 100 is covered by a container 103 so as to nullify an influence of light, other than the light to be measured, by blocking that light.

However, in the above-explained conventional optical spectrum analyzer 100, the inside of the container communicates with the outside the spectrum analyzer 100 in various portions thereof; thus, it is possible that an outer air (atmosphere) will enter in the internal space of the container from the outside of the container.

In an ordinary case, the air which comes from the outside contains a water component such as humidity (moisture). A light having a specific wavelength is absorbed because of a molecular motion of an OH group of an H₂O molecule.

Because of this, in a certain wavelength in the light to be measured, a light having a wavelength which corresponds to an absorption wavelength of the OH group is absorbed by an OH group of H₂O molecules such as in moisture in the air during an operation for dispersing the light in the container 103.

Thus, in the conventional optical spectrum analyzer 100, there was a problem in that the level of optical intensity of the wavelength component of the light to be measured which is dispersed by the refractive grating 8 and incident on the optical detector 2 decreases, and the optical intensity of the light differs from the true value.

Here, in order to solve the above-mentioned problem, it is proposed that an amount of optical absorption by the OH group such as in moisture in the container 13 be calculated in advance when it is necessary to measure the optical intensity of a specific wavelength of the light to be measured which is absorbed by the OH group. It is possible to measure the optical intensity of the wavelength component which is absorbed by the OH group accurately by compensating for the optical intensity which is detected by the optical detector 2 based on the absorption amount which is calculated in the above-explained manner.

However, the absorption amount by the OH group varies over time due to the amount and temperature of the OH groups (humidity) in an optical path; thus, it is difficult to compensate for the measured value accurately.

Also, if an intensity of the specific wavelength component which is absorbed by the OH group is low in the light to be measured, there is a possibility in that no such light can be detected in the conventional optical spectrum analyzer 100 if sensitivity of the optical detector 2 is not sufficient.

### SUMMARY OF THE INVENTION

The present invention was made in consideration of the above-explained problems. An object of the present invention is to provide an optical spectrum analyzer which can measure the level of a specific wavelength of the light to be measured accurately without being affected by the absorption of the specific wavelengths by OH groups.

The optical spectrum analyzer according to the present invention for extracting a specific wavelength a of spectrum of a light (the light L to be measured) which is incident so as to measure the optical intensity of the extracted light and optical spectrum of the light to be measured comprises a spectrum extracting member (refractive grating 8) which extracts a specific wavelength of light which is incident to be measured and is output as a light component, an optical intensity measuring member (optical detector 2 or an optical sensor array 15) which measures an optical intensity of each of the light components, a container (container 13) in which the spectrum extracting member and the optical intensity measuring member are provided, and a substituting member (gas filling port 12, gas exhaust port 14) which is provided in the container and substitutes a gas for an air in the container.

The optical spectrum analyzer according to the present invention is characterized in that the substituting member includes a gas filling port (gas filling port 12) which fills the container with the gas, and a gas exhaust port (gas exhaust port 14) which exhausts the air or the gas.

The optical spectrum analyzer according to the present invention is characterized in that the optical intensity measuring member measures the optical intensity of the light to be measured according to each of specific wavelengths by adjusting an angle of a grating surface of a diffracting grating by a rotating member (rotating structure 9) so as to adjust an angle of light which is dispersed and reflected and to introduce the light according to each specific wavelength into an optical detector (optical detector 2).

The optical spectrum analyzer according to the present invention is characterized in that the optical intensity measuring member measures the optical intensity of the light which is dispersed and reflected at the grating surface of the diffractive grating for each specific wavelength so as to be incident onto a surface of an optical sensor array (optical sensor array 15) based on a relationship of a position of the optical sensor array surface and the wavelength.

The optical spectrum analyzer according to the present invention is characterized in that a gas which is used for substituting method is a nitrogen.

Optical spectrum measuring method according to the present invention for extracting a specific wavelength of a spectrum of a light which is incident to be measured so as to measure optical intensity of the extracted light and optical spectrum of the light to be measured comprises steps of gas substituting step for substituting a predetermined gas for an air which is in the container of the optical spectrum analyzer, spectrum extracting step in which the spectrum of the incident light to be measured is extracted according to each of the specific wavelengths by the spectrum extracting member which is provided in the container so as to be output as a light component, and optical intensity measuring step in which the optical intensity of each of the light components are measured by the optical intensity measuring member which is provided in the container.

The optical spectrum measuring method according to the present invention is characterized in that the substituting method is performed such as the predetermined gas is filled after the air is exhausted in the gas substituting step.

The optical spectrum measuring method according to the present invention is characterized in that in the optical intensity measuring step, the optical intensity of the light to be measured is measured according to each of specific wavelengths by adjusting an angle of grating surface of a diffracting grating by a rotating member so as to adjust an angle of light which is dispersed and reflected and introduce the light according to each specific wavelength into an optical detector.

The optical spectrum measuring method according to the present invention has an optical intensity measuring step, the optical intensity of the light which is dispersed and reflected at the grating surface of the diffractive grating for each specific wavelength is measured so as to be incident onto a surface of an optical sensor array based on a relationship of a position of the optical sensor array surface and the wavelength.

In the optical spectrum analyzer according to the present invention, the air inside of the container in which the refractive grating and the optical detector are provided is replaced by a nitrogen gas so as to fill the interior with the nitrogen gas. By doing this, the OH group is not included in the air which is supplied via the optical path of the light to be measured. Thus, it is possible to measure the optical intensity of the specific wavelength of the light to be measured which is absorbed by the OH group accurately.

More specifically, a gas filling port and a gas exhaust port are provided on the container in the optical spectrum analyzer, and a predetermined gas is filled so as to replace the air with the predetermined gas. Thus, in the optical spectrum analyzer according to the present invention, it is possible to measure the optical intensity of the wavelength of the light to be measured which is absorbed by the OH group in the case in which an influence of the OH group should be eliminated during the spectrum analysis.

By using the optical spectrum analyzer according to the present invention, for example, it is possible to reduce the OH group from the optical path for the light to be measured by performing the substitution for the inside of the container by using the nitrogen gas. Thus, it is possible to reduce the amount of the optical component having a specific wavelength which is absorbed by the OH group. Therefore, it is possible to measure the optical intensity of the specific wavelength at which the absorption occurs due to the OH group with high accuracy.

### BRIEF DESCRIPTION OF THE DRAWINGS

FIG. 1 is a view showing a concept for a structure of an embodiment for an optical spectrum analyzer according to the present invention.

FIG. 2 is a graph showing a result of a measurement of the wavelength (specific wavelength) which was measured by the optical spectrum analyzer according to the present invention which is proximate to the wavelength at which the absorption by the OH group occurs.

FIG. 3 is a view showing a concept for a structure of another embodiment for an optical spectrum analyzer according to the present invention.

FIG. 4 is a view showing a concept for a structure for a conventional optical spectrum analyzer.

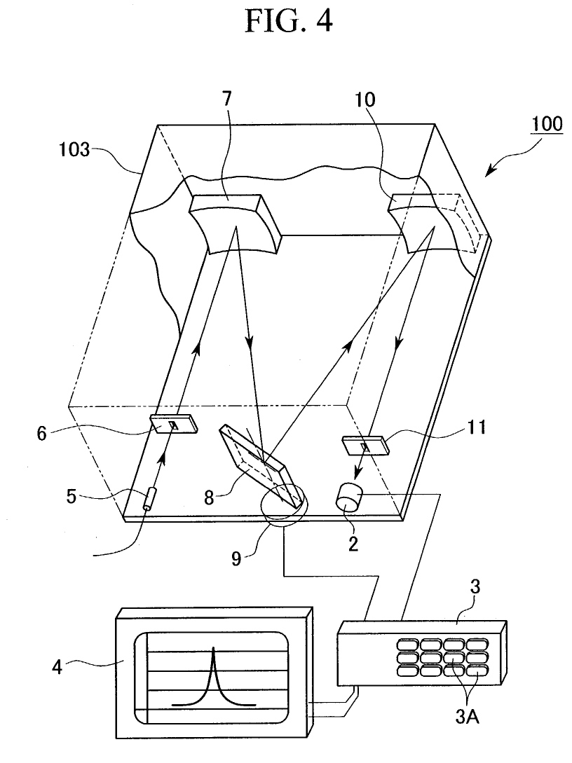

### DETAILED DESCRIPTION OF THE INVENTION

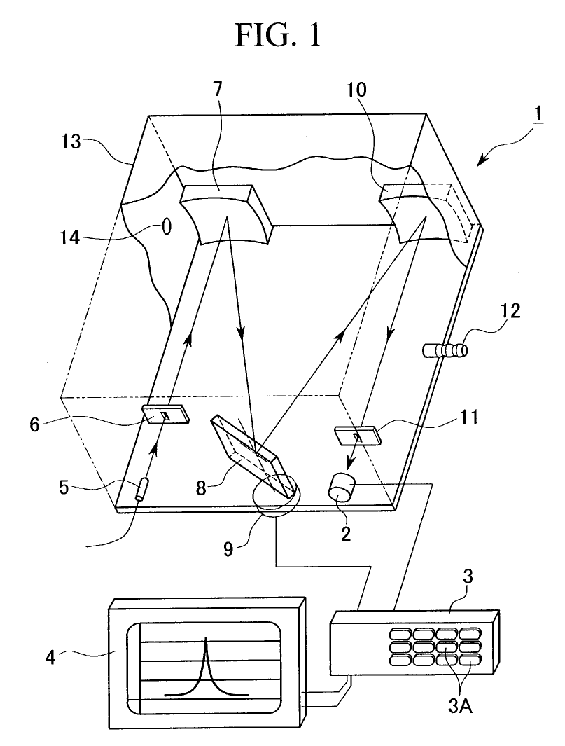

Here, an embodiment of the present invention is explained with reference to the drawings as follows. FIG. 1 is a block diagram showing a structure for one embodiment according to the present invention. Hereinafter, the same reference numerals are applied to corresponding members as shown in the conventional case so as to omit repeated explanation thereof.

In this drawing, an optical spectrum analyzer 1 is provided in a container 13 in which a measuring system is enclosed in an air-tight manner.

In the optical spectrum analyzer 1, a light L to be measured is emitted from a light source which is provided outside of the optical spectrum analyzer via an incident fiber 5.

Subsequently, a concave mirror 7 converts the incident light L to be measured which is emitted via the incident fiber 5 and the incident slit 6 into a parallel light.

A refractive grating 8 is a dispersing element. The refractive grating 8 extracts optical components of the light L to be measured according to specific wavelengths by dispersing the light L to be measured based on the wavelength components of the light L to be measured and reflecting them by different angles according to the wavelengths.

That is, the refractive grating 8 extracts optical components of the incident light L to be measured by adjusting the angle of the refractive grating and controlling the reflection angle for the optical component of the extracted optical component having the specific wavelength.

Therefore, the refractive grating 8 adjusts the optical component which is reflected by the grating surface and input into the optical detector 2 from the concave mirror 10 via the emitting slit 11 having the specific wavelength by rotating the refractive grating 8 by a rotating structure 9 so as to adjust the angle thereat.

The above-explained reflected light L to be measured is an optical component having a specific wavelength which is extracted by the refractive grating 8.

Here, the light L to be measured disperses according to the specific wavelength at each of the grating surfaces on the refractive grating 8 so as to be reflected. The optical component which is dispersed according to the specific wavelength becomes a component light.

The controlling operation for the rotating angle for the rotating structure 9 such as a setting operation for the specific wavelength which the refractive grating 8 reflects the light to be measured is performed by the controlling section 3.

Also, the controlling section 3 performs a determination processing for the operational input signal which is sent from keys 3A and controls the optical detector 2 and the displaying apparatus 4 based on a program which is stored in the controlling section 3.

Subsequently, the concave mirror 10 collects the reflected light (dispersed component light) which is sent from the refractive grating 8 and emits the collected reflected light to the optical detector 2 via the emitting slit 11.

Here, the incident slit 6 and the emitting slit 11 may be in various forms such as a flat slit, a switching slit, and a variable slit such that dimensions such as width and position of the slit are adjusted according to the wavelength resolution and proximity dynamic range by the optical spectrum analyzer 1.

The optical detector 2 puts out the detection signal for voltage level which corresponds to the intensity of the component light which is incident on the controlling section 3.

The controlling section 3 calculates the optical intensity of each of the component lights based on the voltage level of the above-explained input detection signal.

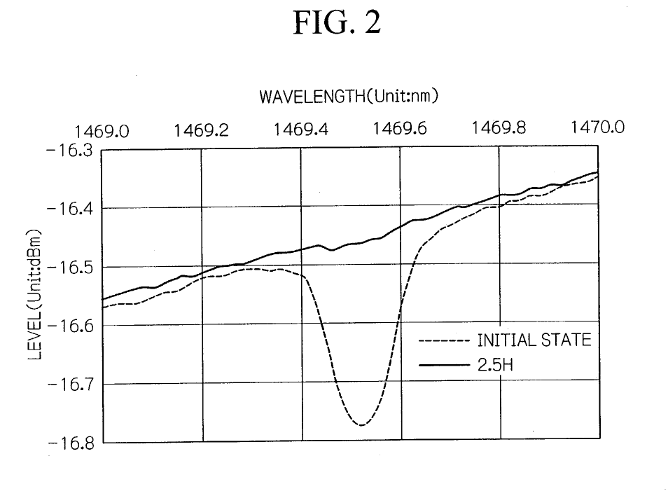

Also, the controlling section 3 displays a relationship (see FIG. 2 showing a graph which is explained later) of the optical intensity of the component light which is obtained in the above-explained calculation and the specific wavelength which is reflected by the refractive grating 8 of which the angle is adjusted by a rotating movement by the rotating structure 9 in the displaying section 4.

In addition, the function of the container 13 in the optical spectrum analyzer 1 according to the present invention is not only for blocking a light which is other than the light to be measured (preventing an interference of light which is other than the light to be measured) but also for preventing an external air from entering the inside of the container so as to enclose (shutter) the predetermined gas such that an enclosed space is produced.

Here, on the container 13, the gas filling port 12 for filling the specific gas and the gas exhaust port 13 for exhausting the air or the gas are provided.

For example, by closing the gas filling port 12 and opening the gas exhaust port 13, the air is exhausted from the gas exhausting port 13 by using a pumping apparatus such as a rotary pump.

Subsequently, after a certain period passes, by opening the gas filling port 12, a nitrogen gas is introduced into the container 13 so as to replace the air with the nitrogen gas.

Next, after the air is replaced by the nitrogen gas, the measuring operation (explained above) for the light L to be measured is performed by the optical spectrum analyzer 1. Therefore, the OH group is eliminated from the optical path for the light to be measured and the component light. By doing this, it is possible to reduce the amount of the light to be measured having the specific wavelength which is absorbed by the OH group in the optical spectrum analyzer 1 greatly. Also, it is possible to perform highly accurate measuring operations because the optical component reaches the optical detector 2 without causing deterioration of the optical component of the light to be measured having the specific wavelength which is absorbed by the OH group.

An experiment in which the air inside the container 13 is replaced by the gas for a predetermined period of time such as 2.5 hours and the amount of the optical component of the light to be measured which is absorbed by the OH group was actually measured was performed. The result is shown in FIG. 2.

In FIG. 2, a horizontal axis indicates a wavelength (nm). A vertical axis indicates an optical intensity (dB). In FIG. 2, an absorption curve (wave line) before the substitution was performed and an absorption curve (continuous line) after the replacement by the nitrogen was performed are shown.

Before performing the replacement by the nitrogen, a central wavelength which is absorbed by the OH group was 1469.52 (nm) and changing amount of the optical intensity in this wavelength was 0.32 (dB). After performing the replacement by nitrogen, it is found that the changing amount of the optical intensity decreased to 0.01 (dB).

As may be understood from FIG. 2, in the optical spectrum analyzer 1 according to the present invention, it is possible to eliminate the moisture in the air containing the OH groups inside the container 13 by performing the replacement by the nitrogen gas. That is, it is possible to prevent the absorption by the OH groups.

In addition, in the optical spectrum analyzer 1 according to the present invention, it is possible to prevent the absorption of the optical component of the light to be measured by the OH groups which is contained in the moisture by performing the replacement by a gas such as not only nitrogen but also other gases which do not absorb in a proximate wavelength to the wavelength of the light to be measured. Also, it is possible to measure the optical intensity of the optical component having the specific wavelength.

Also, it is acceptable that the inside of the container 13 be under vacuum condition or that the inside of the container 13 be filled with the gas in advance instead of replacement performed by using the gas.

As explained above, an embodiment of the present invention was explained in detail. However, it should be understood that the foregoing description is that of the preferred embodiments of the invention and that various changes and modifications may be made thereto without departing from the spirit and scope of the invention as defined in the appended claims.

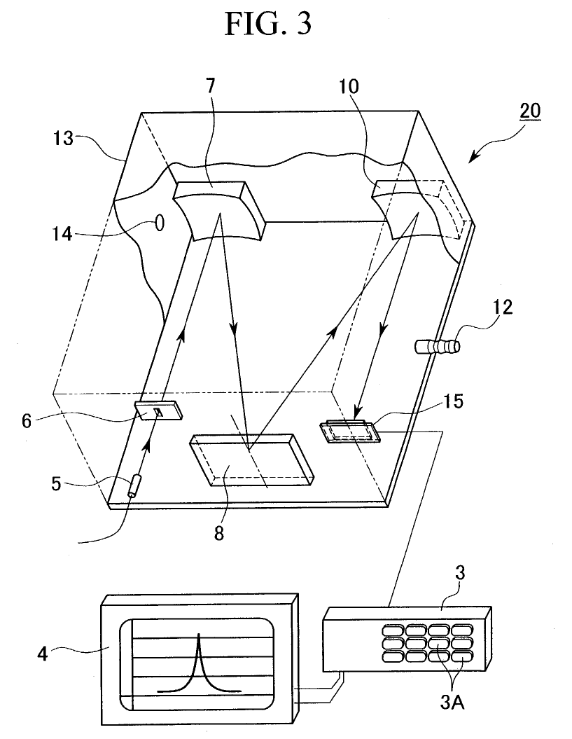

For example, in another embodiment shown in FIG. 3, the same effect as was obtained as in the first embodiment shown in FIG. 1 can be obtained.

In the optical spectrum analyzer 20 shown in FIG. 3 as another embodiment of the present invention, the same reference numerals are applied to corresponding members as shown in the first embodiment so as to omit the repeated explanation thereof.

Here, each of the reflected lights from the refractive grating 8 are collected by the concave mirror 10 so as to be incident onto a surface of the optical sensor array 15. In addition, the position on a surface of the optical sensor array 15 to which the reflected light (component light) is incident corresponds to the specific wavelength of the each of the component lights which are dispersed by the refractive grating 8.

By doing this, each of the optical sensor in the optical sensor array 15 outputs detection signals for the voltage level which corresponds to the optical intensity of the component light which is dispersed and incident based on the position (corresponding to the specific frequency for each of the dispersed component lights) of the optical sensor array 15.

That is, the controlling section 3 calculates the optical intensity of each of the dispersed component lights based on the voltage level of the detection signals which corresponds to the wavelength of the optical sensor array 15 measured by each of the optical sensors. Subsequently, the controlling section 3 displays a graph (for example, FIG. 2) which indicates a relationship of the obtained wavelength (specific wavelength) and the optical intensity of each of the component lights in the displaying section 4.

What is claimed is:

1. An optical spectrum analyzer for extracting a specific wavelength of a spectrum of an light which is incident to be measured so as to measure optical intensity of the extracted light and optical spectrum of the light to be measured comprising:
a spectrum extracting member which extracts a specific wavelength of light which is incident to be measured and outputs the wavelength as a light component;
an optical intensity measuring member which measures an optical intensity of each of the light components;
a container in which the spectrum extracting member and the optical intensity measuring member are provided; and
a substituting member which is provided in the container and replaces air in the container with a gas.

2. An optical spectrum analyzer according to claim 1 wherein the substituting member includes a gas filling port which fills the container with the gas and a gas exhaust port which exhausts the air or the gas.

3. An optical spectrum analyzer according to claim 1 wherein the optical intensity measuring member measures the optical intensity of the light to be measured according to each specific wavelength by adjusting an angle of a grating surface of a diffracting grating by a rotating member so as to adjust an angle of light which is dispersed and reflected and introduces the light according to each specific wavelength into an optical detector.

4. An optical spectrum analyzer according to claim 1 wherein the optical intensity measuring member measures the optical intensity of the light which is dispersed and reflected at the grating surface of the diffractive grating for each specific wavelength so as to be incident onto a surface of an optical sensor array based on a relationship of a position of the optical sensor array surface and the wavelength.

5. An optical spectrum analyzer according to claim 1 wherein a gas which is used for a replacing method is a nitrogen gas.

6. Optical spectrum measuring method, for extracting a specific wavelength of spectrum of a light which is incident to be mesured so as to measure optical intensity of the extracted light and optical spectrum of the light to be measured, comprising the steps of:
gas substituting step for substituting a predetermined gas for an air which is in the container of the optical spectrum analyzer;
spectrum extracting step in which the spectrum of the incident light to be measured is extracted according to each of the specific wavelengths by the spectrum extracting member which is provided in the container so as to be output as a light component; and
optical intensity measuring step in which the optical intensity of each of the light components are measured by the optical intensity measuring member which is provided in the container.

7. Optical spectrum measuring method according to claim 6 wherein the replacing method is performed such as the predetermined gas is filled after the air is exhausted in the gas replacing step.

8. Optical spectrum measuring method according to claim 6 wherein, in the optical intensity measuring step, the optical intensity of the light to be measured is measured according to each of specific wavelengths by adjusting an angle of grating surface of a diffracting grating by a rotating member so as to adjust an angle of light which is dispersed and reflected and introduces the light according to each specific wavelength into an optical detector.

9. Optical spectrum measuring method according to claim 6 wherein, in the optical intensity measuring step, the optical intensity of the light which is dispersed and reflected at the grating surface of the diffractive grating for each specific wavelength is measured so as to be incident onto a surface of an optical sensor array based on a relationship of a position of the optical sensor array surface and the wavelength.
